(19) United States
(12) Patent Application Publication
(10) Pub. No.: US 2022/0005041 A1
(43) Pub. Date: Jan. 6, 2022

(54) ENHANCING EXPLAINABILITY OF RISK SCORES BY GENERATING HUMAN-INTERPRETABLE REASON CODES

(71) Applicant: Intuit Inc., Mountain View, CA (US)

(72) Inventors: Eva Diane Chang, Mountain View, CA (US); Dusan Bosnjakovic, Los Angeles, CA (US)

(73) Assignee: Intuit Inc., Mountain View, CA (US)

(21) Appl. No.: 16/920,642

(22) Filed: Jul. 3, 2020

(51) Int. Cl. G06Q 20/40; G06N 20/00; G06K 9/62

(52) U.S. Cl. CPC G06Q 20/4016; G06K 9/623; G06N 20/00

(57) ABSTRACT

This disclosure relates to systems and methods for identifying risky merchants associated with an electronic payment service. In some implementations, a risk assessment system receives a set of features indicative of one or more risks posed by a merchant enrolled in the electronic payment service, where each feature of the set of features indicative of one or more financial attributes of the merchant. The risk assessment system determines a risk score for the merchant based on the set of features using a trained machine learning model, determines a Shapely additive explanation (SHAP) score for each feature of the set of features, and then divides the set of features into multiple groups of features based on a mapping between the features and their respective indicated financial attributes. The risk assessment system determines a pseudo-SHAP score for each group of features by summing the SHAP scores determined for the features in the respective group of features, and then determines a financial risk or a risk of fraud posed by the merchant based on the determined risk score and the pseudo-SHAP scores.

### TECHNICAL FIELD

This disclosure relates generally to determining risks associated with an electronic payment service, and more specifically, to determining a risk of fraud or a financial risk posed by a merchant enrolled in the electronic payment service.

### DESCRIPTION OF RELATED ART

Many merchants and small businesses outsource their payment processing operations to an electronic payment service (such as Quickbooks) to reduce overhead and increase operational efficiencies. Unfortunately, these merchants and small businesses may engage in fraudulent activities, and may also pose a financial risk to the electronic payment service. For example, when customers return items purchased from selected merchants via the electronic payment service, the electronic payment service may have arrangements with the selected merchants where the electronic payment service refunds the purchase amounts to the customers in chargeback transactions prior to reimbursement from the selected merchants for the chargeback amounts. If one or more of the selected merchants do not provide reimbursement for the chargeback amounts, the electronic payment service may be responsible for these chargeback amounts. Because these non-reimbursed merchant chargeback amounts represent a financial loss for the electronic payment service, it is desirable to identify merchant chargebacks (and other financial transactions) for which the financial risks posed to the electronic payment service exceeds a certain threshold.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter. Moreover, the systems, methods and devices of this disclosure each have several innovative aspects, no single one of which is solely responsible for the desirable features disclosed herein.

One innovative aspect of the subject matter described in this disclosure can be implemented as a method for identifying risky merchants enrolled in an electronic payment service. The method can be performed by a risk assessment system associated with the electronic payment service, and may include receiving a set of features indicative of one or more risks posed by a merchant enrolled in the electronic payment service, determining a risk score for the merchant based on the set of features using a trained machine learning model, determining a Shapely additive explanation (SHAP) score for each feature of the set of features, dividing the set of features into multiple groups of features based on a mapping between each feature and the corresponding one or more financial attributes, determining a pseudo-SHAP score for each group of features by summing the SHAP scores determined for the features in the respective group of features, and determining a financial risk or a risk of fraud posed by the merchant based on the determined risk score and the pseudo-SHAP scores. The machine learning model can be trained using one or more historical sets of features associated with the merchant.

Each feature of the set of features may be indicative of one or more financial attributes of the merchant, and each group of features can be mapped to a corresponding category of financial attributes based on similarities between the attributes indicated by the set of features. The financial attributes can include one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant.

The method can also include providing the risk score, the pseudo-SHAP scores determined for the groups of features, and one or more financial transactions of the merchant to one or more human risk analysts associated with the electronic payment service, and receiving an estimated accuracy of the risk score based at least in part on the pseudo-SHAP scores from the one or more human risk analysts. In some instances, the method can also include determining an impact value for each group of features, the impact value indicating a degree to which the respective group of features contributed to the risk score. In other instances, the method can also include determining a weighting factor for each feature of the set of features based at least in part on the one or more financial attributes indicated by the respective feature, and applying the weighting factors to one or more features prior to determining the risk score.

Another innovative aspect of the subject matter described in this disclosure can be implemented in a risk assessment system that can identify risky merchants enrolled in an electronic payment service. In some implementations, the risk assessment system includes one or more processors and a memory coupled to the one or more processors. The memory can store instructions that, when executed by the one or more processors, cause the risk assessment system to perform operations including receiving a set of features indicative of one or more risks posed by a merchant enrolled in the electronic payment service, determining a risk score for the merchant based on the set of features using a trained machine learning model, determining a Shapely additive explanation (SHAP) score for each feature of the set of features, dividing the set of features into multiple groups of features based on a mapping between each feature and the corresponding one or more financial attributes, determining a pseudo-SHAP score for each group of features by summing the SHAP scores determined for the features in the respective group of features, and determining a financial risk or a risk of fraud posed by the merchant based on the determined risk score and the pseudo-SHAP scores. The machine learning model can be trained using one or more historical sets of features associated with the merchant.

Each feature of the set of features may be indicative of one or more financial attributes of the merchant, and each group of features can be mapped to a corresponding category of financial attributes based on similarities between the attributes indicated by the set of features. The financial attributes can include one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant.

The risk assessment system can also provide the risk score, the pseudo-SHAP scores determined for the groups of features, and one or more financial transactions of the merchant to one or more human risk analysts associated with the electronic payment service, and can receive an estimated accuracy of the risk score based at least in part on the pseudo-SHAP scores from the one or more human risk analysts. In some instances, the risk assessment system can determine an impact value for each group of features, the impact value indicating a degree to which the respective group of features contributed to the risk score. In other instances, the risk assessment system can determine a weighting factor for each feature of the set of features based at least in part on the one or more financial attributes indicated by the respective feature, and apply the weighting factors to one or more features prior to determining the risk score.

Another innovative aspect of the subject matter described in this disclosure can be implemented in an apparatus for identifying risky merchants enrolled in an electronic payment service. In some implementations, the apparatus can include means for receiving a set of features indicative of one or more risks posed by a merchant enrolled in the electronic payment service, means for determining a risk score for the merchant based on the set of features using a trained machine learning model, means for determining a Shapely additive explanation (SHAP) score for each feature of the set of features, means for dividing the set of features into multiple groups of features based on a mapping between each feature and the corresponding one or more financial attributes, means for determining a pseudo-SHAP score for each group of features by summing the SHAP scores determined for the features in the respective group of features, and means for determining a financial risk or a risk of fraud posed by the merchant based on the determined risk score and the pseudo-SHAP scores. The machine learning model can be trained using one or more historical sets of features associated with the merchant.

Each feature of the set of features may be indicative of one or more financial attributes of the merchant, and each group of features can be mapped to a corresponding category of financial attributes based on similarities between the attributes indicated by the set of features. The financial attributes can include one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant.

The apparatus can also provide the risk score, the pseudo-SHAP scores determined for the groups of features, and one or more financial transactions of the merchant to one or more human risk analysts associated with the electronic payment service, and can receive an estimated accuracy of the risk score based at least in part on the pseudo-SHAP scores from the one or more human risk analysts. In some instances, the apparatus can determine an impact value for each group of features, the impact value indicating a degree to which the respective group of features contributed to the risk score. In other instances, the apparatus can determine a weighting factor for each feature of the set of features based at least in part on the one or more financial attributes indicated by the respective feature, and apply the weighting factors to one or more features prior to determining the risk score.

### BRIEF DESCRIPTION OF THE DRAWINGS

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

FIG. 1 shows a block diagram of an environment within which various aspects of the subject matter disclosed herein may be implemented.

FIG. 2 shows a block diagram of a risk assessment system, according to some implementations.

FIG. 3 shows an example process flow that can be employed by the risk assessment system of FIG. 2, according to some implementations.

FIG. 4 shows an illustrative flowchart depicting an example operation for identifying financially risky or fraudulent merchants enrolled in an electronic payment service, according to some implementations.

FIG. 5A shows an illustrative flowchart depicting an example operation for determining an impact value for a set of features, according to some implementations.

FIG. 5B shows an illustrative flowchart depicting an example operation for applying weighting factors to one or more features of a merchant, according to some implementations.

FIG. 5C shows an illustrative flowchart depicting an example operation for determining an accuracy of the risk score, according to some implementations.

Like reference numbers and designations in the various drawings indicate like elements.

### DETAILED DESCRIPTION

The following description is directed to certain implementations for the purposes of describing the innovative aspects of this disclosure. However, a person having ordinary skill in the art will readily recognize that the teachings herein can be applied in a multitude of different ways. It may be readily understood that certain aspects of the disclosed systems and methods can be arranged and combined in a wide variety of different configurations, all of which are contemplated herein. The described implementations may be implemented in, or associated with, any electronic or online payment platform, investment system, banking system, or financial system for which it is desirable to accurately determine the financial risk and/or the risk of fraud posed by an entity enrolled in or otherwise associated with the system. Thus, although described herein with respect to an electronic payment service, aspects of the present disclosure are equally applicable to other electronic or online systems.

Implementations of the subject matter described in this disclosure can be used to identify merchants who may pose a financial risk or a risk of fraud to an electronic payment service prior to their enrolling in, or attempting to enroll in, the electronic payment service. In some implementations, a risk assessment system can interface with the electronic payment service and evaluate online financial transactions of a merchant for such risks based on one or more sets of features associated with the merchant. Each set of features may be indicative of various financial attributes of the merchant, and can be provided to a machine learning model trained to determine a risk score for the merchant. The risk assessment system can also determine a Shapely additive explanation (SHAP) score for each of the features, divide the merchant's features into multiple groups of features based on similarities of their respective attributes, and determine a pseudo-SHAP score for each group of features based on the feature-level SHAP scores for the respective group. The risk assessment system can evaluate the pseudo-SHAP scores in view of the risk score to determine potential financial risk or risk of fraud posed by the merchant.

In some implementations, the risk assessment system can utilize human risk analysts to determine an accuracy of the risk score determined for a respective merchant. For example, the risk assessment system can provide the risk score, the group-level pseudo-SHAP scores, and one or more financial transactions of the merchant to one or more human risk analysts associated with the electronic payment service. The one or more human risk analysts can use the group-level pseudo-SHAP scores to evaluate certain transactions or trends of the merchant in greater detail to identify financial risks, payment defaults, and fraudulent behavior of the merchant, and then use the evaluated financial transactions to determine the accuracy of the risk score generated by the risk assessment system.

Various implementations of the subject matter disclosed herein provide one or more technical solutions to the technical problem of identifying merchants enrolled in an electronic payment service that pose a certain financial risk or fraud risk to the electronic payment service by applying machine learning engines to one or more sets of merchant features to determine a level of financial risk and/or a level of fraud of such merchants. As such, various aspects of the present disclosure provide a unique computing solution to a unique computing problem that did not exist prior to electronic payment services that facilitate online financial transactions, online payments, and online chargebacks between large numbers of merchants and customers. More specifically, the problem of identifying financial risks and/or risks of fraud associated with electronic payment services did not exist prior to the widespread adoption of the Internet used as a communications medium over which vast numbers of financial or other electronic commerce-related transactions can be facilitated, and is therefore a problem rooted in and created by technological advances that made the Internet a necessity for facilitating electronic financial transactions, within which fraudulent or financially risky transactions must be accurately differentiated from legitimate transactions.

As the commercial success and widespread adoption of electronic payment services increases, the dollar value of online purchases, deposits, transfers, and other transactions can now be expressed in terms of trillions of US dollars per year This rapid growth in online commerce, banking, investment, and other fields has also resulted in a significant increase in the amount of financial data that can be evaluated to identify certain transactions and/or financial attributes indicative of excessive financial risk or fraud. For example, while the amount digital data generated by several online financial transactions may be small enough to be evaluated for risks, fraud, and other trends by humans, the vast amount of financial transactions and other financial data generated by modern electronic payment services require the computational power of modern processors and machine learning models to accurately identify such risks, in real-time, so that appropriate action can be taken to reduce or eliminate such risks. Therefore, implementations of the subject matter disclosed herein are not an abstract idea such as organizing human activity or a mental process that can be performed in the human mind, for example, because it is not practical, if even possible, for a human mind to evaluate the transactions of thousands to millions, or more, of merchants based on corresponding sets of thousands of merchant features at the same time, in real-time, to identify merchants demonstrating financially risky or fraudulent behavior.

Moreover, various aspects of the present disclosure effect an improvement in the technical field of assessing financial risks and risks of fraud posed by merchants enrolled in an electronic payment service by using group-level pseudo-SHAP scores to identify certain financial transactions for further investigation by human risk analysts, for example, rather than conventional solutions that rely on feature-level SHAP scores. More specifically, for environments in which a merchant can be associated with thousands of different features or financial attributes, the number of group-level pseudo-SHAP scores may be several orders of magnitude less than the number of feature-level SHAP scores, and therefore can be more readily usable by human risk analysts to more fully investigate suspicious financial transactions or behaviors of a merchant. In addition, when there are thousands of features to be considered for each merchant, many features can be assigned the same feature-level SHAP score, thereby rendering it difficult (if not impossible) to discern differences between levels of contribution to the risk score for such features. Implementations of the subject matter disclosed herein solve this problem by grouping features having similar attributes together and determining a single pseudo-SHAP score for the group of features. In this way, the impact of a large number of features having similar attributes on the risk score can be readily discerned by human risk analysts, which can increase the speed with which the human risk analysts are able to identify risky or fraudulent financial transactions associated with a particular merchant and take appropriate action (such as declining a transaction or initiating further review).

In the following description, numerous specific details are set forth such as examples of specific components, circuits, and processes to provide a thorough understanding of the present disclosure. The term “coupled” as used herein means connected directly to or connected through one or more intervening components or circuits. The terms “processing system” and “processing device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example implementations. In other instances, well-known circuits and devices are shown in block diagram form to avoid obscuring the present disclosure. Some portions of the detailed descriptions which follow are presented in terms of procedures, logic blocks, processing, and other symbolic representations of operations on data bits within a computer memory.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory, and the like.

Several aspects of electronic payment services will now be presented with reference to various apparatus and methods. These apparatus and methods will be described in the following detailed description and illustrated in the accompanying drawings by various blocks, components, circuits, devices, processes, algorithms, and the like (collectively referred to herein as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example implementations, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

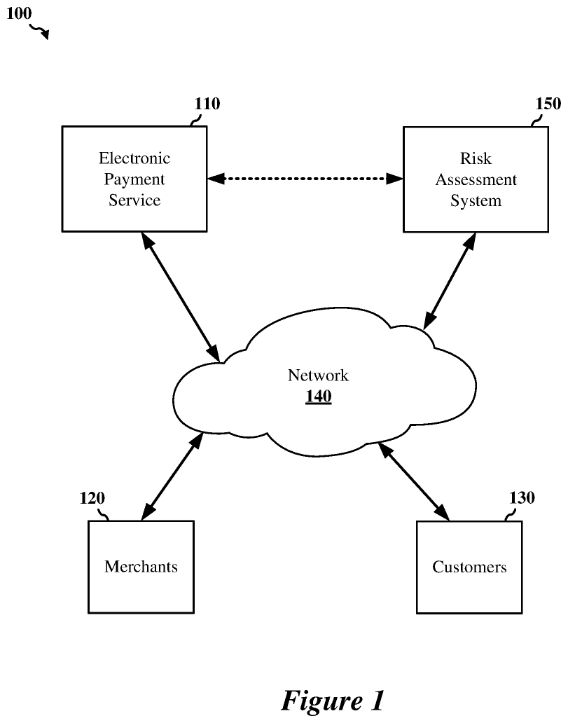

FIG. 1 shows an environment 100 within which aspects of the present disclosure can be implemented. The environment 100 is shown to include an electronic payment service 110, one or more merchants 120, one or more customers 130, a communications network 140, and a risk assessment system 150. In some implementations, the example system 100 may include any suitable number of merchants 120 and/or customers 130. In addition, or in the alternative, the example system 100 may include other components, devices, or systems not shown for simplicity.

The electronic payment service 110 can facilitate electronic transactions related to e-commerce such as, for example, online purchases, returns, chargebacks, credit, and transfers. In some instances, the electronic payment service can also facilitate or process electronic transactions related to banking, investment, and other fields. In some implementations, the electronic payment service 110 can be implemented with, or may include, a plurality of servers of various types such as, for example, a web server, a file server, an application server, a database server, a proxy server, or any other server suitable for performing functions or processes described herein, or any combination thereof. Each server may be a unitary server or a distributed server spanning multiple computers or multiple datacenters, and may include hardware, software, or embedded logic components or a combination of two or more such components for carrying out the appropriate functionalities implemented or supported by the server.

The merchants 120 can be any suitable person or entity for which online purchases, returns, chargebacks, and/or other transactions are facilitated by the electronic payment service 110. For example, the merchants 120 can be traditional brick-and-mortar businesses, can be online-only businesses, or can be hybrid businesses having a physical locations and an online presence. For purposes of discussion herein, merchants enrolled with the electronic payment service 110 can use the electronic payment service 110 to facilitate financial transactions (including chargebacks) with its customers 130. In some instances, the merchants 120 may use the electronic payment service 110 for non-customer transactions such as payroll, taxes, and transacting with suppliers or vendors.

The customers 130 can communicate and interact with the merchants 120 over the network 140 using a client device (client device not shown for simplicity). The client device can be any suitable computing device such as, for example, a desktop computer, a laptop computer, a personal digital assistant, a cellular telephone, a smartphone, a tablet computer, a game console, an electronic book reader, or another suitable communications device with which the customers 130 can purchase goods and/or services from one or more merchants 120 enrolled in the electronic payment service 110.

The network 140 provides communication links between the electronic payment service 110, the merchants 120, and the customers 130. The network 140 may be any suitable one or more communication networks including, for example, the Internet, a wide area network (WAN), a metropolitan area network (MAN), a wireless local area network (WLAN), a personal area network (PAN) such as Bluetooth®, a radio access network (RAN) such as a Fifth Generation (5G) New Radio (NR) system, a wired network, a cable network, a satellite network, or any other suitable network. In some instances, the communications network 150 can facilitate online purchases of goods and/or services between the merchants 120 and customers 130, facilitate various online financial transactions between the merchants 120 and customers 130, and/or facilitate other information exchanges between the merchants 120 and customers 130.

The risk assessment system 150 can receive financial, transactional, and other information for the enrolled merchants 120, and can transform, or otherwise process, the received information into predictive models that can be used to determine various risks posed by the enrolled merchants 120. The information can indicate the type of business handled by a respective merchant, the type of customers who purchase merchandise or services from the respective merchant, the dollar amounts of transactions between the respective merchant and each of its customers. The information can also indicate the number of chargebacks for a respective merchant during a time period, the dollar amounts of the merchant chargebacks during the time period, identities of the customers involved in the merchant chargebacks, and/or the likelihood that a given transaction is or will become a merchant chargeback.

The information for a respective merchant 120 can be provided to the risk assessment system 150 as a set of features, and the risk assessment system 150 can use a machine learning model to determine a risk score based on the respective merchant's set of features. The risk score can indicate the likelihood that the respective merchant will be able to satisfy its outstanding debt obligations in a timely manner, and can be used to identify certain financial transactions or attributes of the respective merchant that are to be more fully investigated by human risk analysts. In some instances, each feature may be indicative of one or more financial attributes of the merchant including, for example, a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant.

In some implementations, the risk assessment system 150 can determine a Shapely additive explanation (SHAP) score for each of the features associated with the respective merchant. The risk assessment system 150 can divide or classify a set of features into multiple groups of features based on similarities of the attributes indicated by the features. For example, the risk assessment system 150 can group features pertaining to the same or similar financial attribute together and accord the group features a suitable importance or weight. Pseudo-SHAP scores can be determined for the groups of features, for example, such that any particular feature or category of features is represented by a single Pseudo-SHAP score, rather than a multitude of uncorrelated feature-level SHAP scores. The risk assessment system 150 can combine the pseudo-SHAP scores and the risk score to determine a financial risk or a risk of fraud posed by the respective merchant.

For example, when a customer 130 purchases merchandise from one of the merchants 120, the electronic payment service 110 may withdraw funds from the customer's bank, and deposit the funds into the merchant's bank account. If the customer subsequently disputes the transaction or demands a refund of monies paid to the merchant, the electronic payment service 110 may provide a refund to the customer 130 before reimbursement from the merchant. This scenario is commonly known as a merchant chargeback. If the merchant 120 does not provide reimbursement for the chargeback, the electronic payment service 110 may be responsible for the chargeback amount and incur financial loss. As such, it is desirable for the electronic payment service to determine whether a particular merchant is likely to provide reimbursement for such merchant chargebacks (and other financial obligations) in a timely manner.

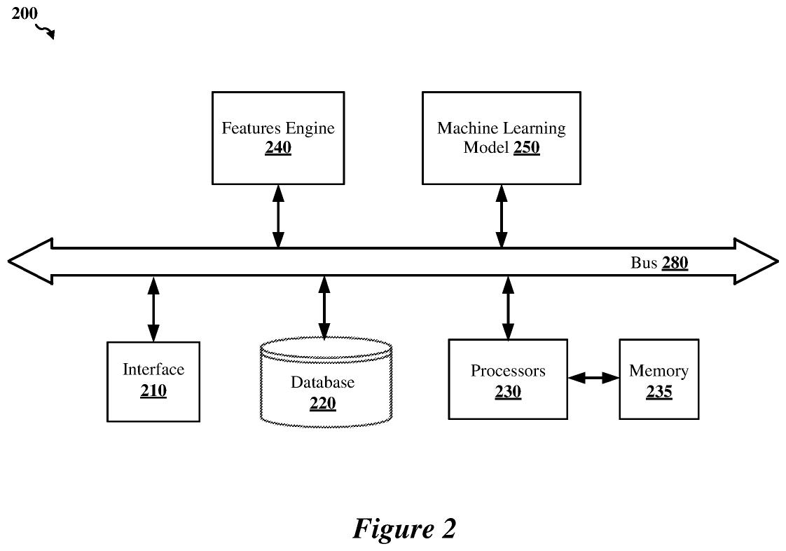

FIG. 2 shows a block diagram of a risk assessment system 200, according to some implementations. In some instances, the risk assessment system 200 may be one example of the risk assessment system 150 of FIG. 1. Although described herein with respect to determining or assessing financial and fraud risks posed to an electronic payment service by one or more enrolled merchants, in some other implementations, the risk assessment system 200 can detect other financial risks and/or predict fraudulent activity by merchants. The risk assessment system 200 is shown to include an input/output (I/O) interface 210, a database 220, one or more processors 230, a memory 235 coupled to the one or more processors 230, a features engine 240, a machine learning model 250, and a data bus 280. The various components of the risk assessment system 200 may be connected to one another by the data bus 280, as depicted in the example of FIG. 2. In other implementations, the various components of the risk assessment system 200 may be connected to one another using other suitable signal routing resources.

The interface 210 may include any suitable devices or components that allow a user to provide information (such as input data) to the risk assessment system 200 and/or to receive information (such as output data) from the risk assessment system 200. In some instances, the interface 210 includes at least a display screen and an input device (such as a mouse and keyboard) that allows users to interface with the risk assessment system 200 in a convenient manner. The interface 210 may also be used to exchange data and information with the electronic payment service 110 of FIG. 1. For example, the interface 210 may receive one or more sets of merchant features, may receive one or more weighting factors that can be selectively applied to the one or more features, may receive one or more financial transactions involving each merchant 120. Information that can be received from the risk assessment system 200 can include risk scores, SHAP scores, pseudo-SHAP scores, financial risks, and risks of fraud for each merchant enrolled in the electronic payment service.

The database 220 can store any suitable information relating to the merchants 120, the customers 130, financial transactions between the merchants 120 and the customers 130, and other suitable information. For example, the database 230 can store one or more sets of features associated with each of plurality of merchants enrolled in, or applying for enrollment in, the electronic payment service. As discussed above, a merchant's features may be indicative of one or more risks posed by the merchant, and can include one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, a type of customers associated with the merchant, and/or other suitable information. In some instances, the database 220 can store categories of financial attributes, and can store mappings between feature groups defined by risk assessment system 200 and any number of financial attribute categories.

The database 220 can also store information relating to the merchant's customers, banking operations, credit information, tax information, vendors, investors, and other suitable data sets. In some instances, the database 220 can be a relational database capable of manipulating any number of various data sets using relational operators, and present one or more data sets and/or manipulations of the data sets to a user in tabular form and capable. The database 220 can also use Structured Query Language (SQL) for querying and maintaining the database, and/or can store merchant feature sets and financial information relevant to the merchants in tabular form, either collectively in an feature table or individually within each of the data sets.

The processors 230, which may be used for general data processing operations (such as transforming data stored in the database 220 into usable information), may be one or more suitable processors capable of executing scripts or instructions of one or more software programs stored in the fraud detection system 200 (such as within the memory 235). The processors 230 may be implemented with a general purpose single-chip or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. In one or more implementations, the processors 230 may be implemented as a combination of computing devices (such as a combination of a DSP and a microprocessor, a plurality of microprocessors, one or more microprocessors in conjunction with a DSP core, or any other such configuration).

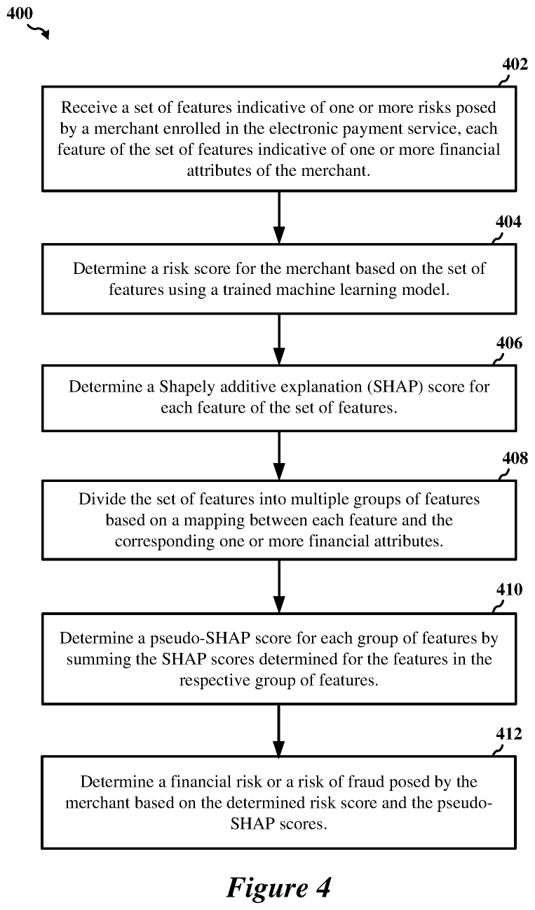

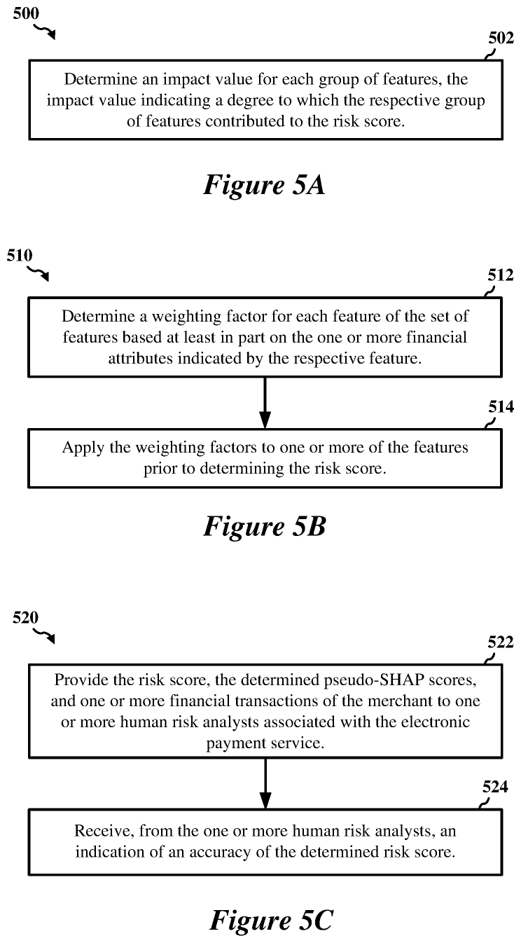

The memory 235 may be any suitable persistent memory (such as one or more nonvolatile memory elements, such as EPROM, EEPROM, Flash memory, a hard drive, etc.) that can store any number of software programs, executable instructions, machine code, algorithms, and the like that, when executed by the processors 230, causes the system 200 to perform at least some of the operations described with reference to one or more of FIGS. 4, 5A, 5B, 5C, and 5D. In some instances, the memory 235 can also store training data, seed data, and/or test data for the machine learning engine 250.

The features engine 240 can be used to receive, obtain, or determine one or more sets of features for each enrolled merchant. As discussed above, a merchant's features may be indicative of one or more risks posed by the merchant, and can include one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, a type of customers associated with the merchant, and/or other suitable information.

The features engine 240 can also determine mappings between the received features and a multitude of different financial attributes. The mappings can be used to divide the features into one or more groups of features based on similarities of attributes indicated by the features. The mappings and/or feature group information can be used by the group scoring engines 270 to determine pseudo-SHAP scores for different groups of features. In some instances, the features engine 240 can also determine impact values indicative of the degree to which individual features or groups of features contribute to the risk score. In some instances, the features engine 240 can apply weighting factors to one or more features based at least in part on the financial attributes indicated by the various features. For example, if a first feature is found to be a better indicator of financial risk than a second feature, the first feature may be assigned a greater weight than the second feature when determining the risk score to reflect the greater importance or relevance of the first feature (as compared with the second feature).

The machine learning model 250 can include one or more machine learning algorithms based on one or more of decision trees, random forests, logistic regression, nearest neighbors, classification trees, control flow graphs, support vector machines, naïve Bayes, Bayesian Networks, value sets, hidden Markov models, and neural networks configured to determine a risk score for the merchant based on one or more sets of features associated with the merchant. The machine learning model 250 can include any suitable number of machine learning engines, and can take the form of an extensible data structure that represents sets of behaviors, features, or characteristics of the merchants. In some instances, the machine learning model 250 can be trained to determine whether certain merchant features are accurate predictors of financial risk and risk of fraud, and can apply greater weightings to such merchant features when determining the risk score for a merchant. The machine learning model 250 can be trained using historical merchant data (such as previously evaluated or modeled feature sets of the merchant), either with supervision or without supervision. In some instances, the machine learning model 250 can be iteratively trained using current sets of merchant features. In some other instances, the machine learning model 250 can be updated or modified based on more detailed investigations of certain financial transactions or merchant behaviors conducted by human risk analysts.

The machine learning model 250 can be configured to generate a SHAP score for each feature in the received set of features. In general, SHAP scores are based on game theory techniques, and can provide a quantitative representative of the contribution of each feature to the risk score determined for a respective merchant. For example, a large positive SHAP score may indicate that the feature played a relatively large role in the overall risk score being high, while a large negative SHAP score may indicate that the feature played a relatively large role in maintaining a low risk score. These feature-level SHAP scores may increase the transparency of the machine learning model 250 by quantitatively expressing the contribution of each feature to the risk score determined for a respective merchant. In some instances, the machine learning model 250 can correlate the feature-level SHAP scores with the risk score.

Although SHAP scores can be very effective in illustrating the importance or contribution of each feature to the risk score of the merchant, similar features may have a similar SHAP score, leading to potential processing inefficiencies due to excessive or duplicative data. When a data set includes a large number of features (such as thousands of features), many features may have the same or similar SHAP score, and therefore may not be distinguishable from each other. As a result, such feature-level SHAP scores may not provide the human risk analysts with sufficient insight or reasons indicating why a particular financial transaction or merchant behavior has a high SHAP score, which can make it difficult (if not impossible) for the human risk analysts to determine which financial transactions or merchant behaviors to more fully investigate for indications of financial risk or risk of fraud. Moreover, although it may be possible for human risk analysts to evaluate a few feature-level SHAP scores (such as dozen or so SHAP scores) for indications of risk, the risk assessment system 200 can be deployed in environments for which thousands of merchant features, and thus thousands of SHAP scores, are available for evaluation. Human risk analysts are not capable of processing such vast amounts of data to identify financial risks or risks of fraud, in real time, so that appropriate action can be taken (such as declining a transaction).

In accordance with some aspects of the present disclosure, the machine learning model 250 can divide the features into different groups of features based on levels of similarity between their respective financial attributes, determine a pseudo-SHAP score for each group of features, and then determine the overall financial risk or risk of fraud posed by the merchant based on the risk score and the group-level SHAP scores. In some instances, the features can be divided into groups such that the features within each group share one or more common financial attributes of the merchant. In this way, each group of features can correspond to a different category of features, and therefore each group-level pseudo SHAP score can indicate the impact of a corresponding category of features on the risk score. For example, the machine learning model 250 can group features indicating time periods between financial transactions of the merchant together in a first group, can group features indicating the dollar amounts of the financial transactions of the merchant together in a second group, can group features indicating the number of chargebacks to the merchant together in a third group, and so on.

The number of group-level SHAP scores determined for a given set of features can be orders of magnitude less than the number of feature-level SHAP scores determined for the given set of features. The risk assessment system 200 can provide the group-level SHAP scores, rather than the feature-level SHAP scores, to assist human risk analysts in identifying particular financial transactions or merchant behaviors to for closer scrutiny. As discussed above, when there are thousands of features to be considered for each merchant, many features can be assigned the same feature-level SHAP score, thereby rendering it difficult (if not impossible) to discern differences between levels of contribution to the risk score for such features. The risk assessment system 200 solves this problem by grouping features having similar attributes together and determining a single pseudo-SHAP score for the group of features. In this way, the impact of a large number of features having similar attributes on the risk score can be readily discerned by human risk analysts, which can increase the speed and efficiency with which the human risk analysts are able to identify risky or fraudulent financial transactions associated with a particular merchant and take appropriate action (such as declining a transaction or initiating further review).

Non-authentic, such as fake, customers or merchants can pose financial risks and risks of fraud to electronic payment services. These fake customers tend to have irregular behaviors that can be identified by evaluating a variety of their financial transactions and financial attributes. Uninformed manual reviews of such financial transactions and financial attributes by eager but under-equipped human financial risk analysts may be insufficient to detect such fake customers. However, by providing human risk analysts with a manageable number of group-level pseudo-SHAP scores, rather than an overwhelming number of feature-level SHAP scores, the risk assessment system 200 also is not a realistic solution due to issues relating to information overload from SHAP values produced at the feature level. Instead, humans need easily understandable output from ML models, such as ML classification model 300, to be able to understand why these companies (referring to merchants) present risk of loss to EPS, which can lose money as a by-product of payment processing irregularities, even without providing loan monies directly to the merchant client.

In some instances, the group-level SHAP scores can also be used to modify or update the machine learning model 250 in a manner that increases the level of accuracy with which risks posed by merchant can be predicted. In addition, or in the alternative, the machine learning model 250 can use natural language processing to parse large numbers of features and then divide the features into a multitude of groups of features based on similarities in their attributes or other characteristics.

The particular architecture of the risk assessment system 200 shown in FIG. 2 is but one example of a variety of different architectures within which aspects of the present disclosure may be implemented. For example, in other implementations, the risk assessment system 200 may not include features engine 240, the functions of which may be implemented by the processors 230 executing corresponding instructions or scripts stored in the memory 235. Similarly, in some other implementations, one or more of the functions of the machine learning model 250 may be performed by the processors 230 executing corresponding instructions or scripts stored in the memory 235.

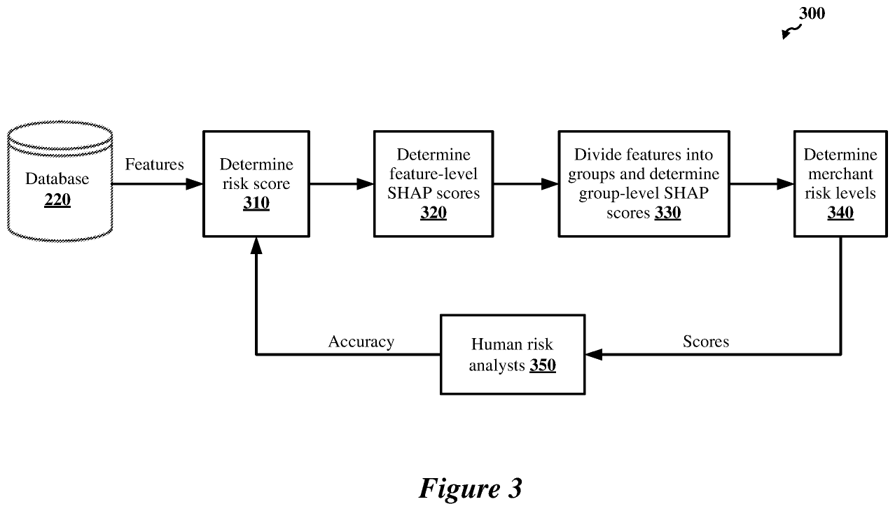

FIG. 3 shows an example process flow 300 that can be performed by the risk assessment system 200 of FIG. 2, according to some implementations. At block 310, the risk assessment system 200 receives a set of features for a merchant from the database 220, and determines a risk score for the merchant based on the received set of features. In some instances, the risk score can be determined using the machine learning model 250. The machine learning model 250 can be seeded with historical data (such as historical sets of features) associated with the merchant, and can be trained to generate the risk score in a manner that is indicative of a financial risk and/or a risk of fraud posed by the merchant. In some instances, the machine learning model 250 can use the received set of features to determine a likelihood of the merchant defaulting on financial obligations associated with one or more financial transactions (such as merchant chargebacks) involving the merchant.

At block 320, the risk assessment system 200 determines a SHAP score for each feature of the received set of features. In some instances, the SHAP scores can be determined by the machine learning model 250. As discussed, although SHAP scores can be very effective in illustrating the importance or contribution of each feature to the risk score of the merchant, similar features may have the SHAP score, and therefore may not be distinguishable from each other. As a result, such feature-level SHAP scores may not provide the human risk analysts with sufficient insight or reasons indicating why a particular financial transaction or merchant behavior has a high SHAP score.

At block 330, the risk assessment system 200 divides the features into different groups of features, and determines a pseudo-SHAP score for each group of features. In some instances, the group-level pseudo-SHAP scores can be determined by the machine learning model 250. By dividing the features into different group that share one or more common attributes, the group-level pseudo-SHAP scores can indicate the impact of each category of attributes on the overall risk score. In this way, the risk assessment system 200 can significantly reduce the number of SHAP scores provided to the human risk analysts for a manual investigation of certain financial transactions or behaviors of the merchant.

At block 340, the risk assessment system 200 determines a financial risk or a risk of fraud posed by a merchant based on the risk score and the group-level pseudo-SHAP scores. In some instances, the financial risk or a risk of fraud posed by a merchant can be determined by the machine learning model 250. The risk score, the group-level pseudo-SHAP scores, and one or more financial transactions of the merchant can be provided to the human risk analysts for closer scrutiny.

At block 350, one or more human risk analysts can receive the risk score, the group-level pseudo-SHAP scores, and one or more financial transactions of a merchant. The human risk analysts can use the group-level pseudo-SHAP scores to identify which of the one or more financial transactions to more fully investigate for financial risk, financial default, or indications of fraud. In some instances, the human risk analysts can use the group-level pseudo-SHAP scores and/or the results of their investigation to determine an accuracy of the risk score generated by the risk assessment system 200.

FIG. 4 shows an illustrative flowchart depicting an example operation 400 for identifying risky merchants enrolled in an electronic payment service. The operation 400 may be performed by one or more processors of the risk assessment system 150 of FIG. 1 or the risk assessment system 200 of FIG. 2. In some implementations, one or more portions of the operation 400 may be performed or implemented by the machine learning model 300 of FIG. 3.

At block 402, the risk assessment system receives a set of features indicative of one or more risks posed by a merchant enrolled in the electronic payment service, each feature of the set of features indicative of one or more financial attributes of the merchant. At block 404, the risk assessment system determines a risk score for the merchant based on the set of features using a trained machine learning model. At block 406, the risk assessment system determines a Shapely additive explanation (SHAP) score for each feature of the set of features. At block 408, the risk assessment system divides the set of features into multiple groups of features based on a mapping between the features and their respective indicated financial attributes. At block 410, the risk assessment system determines a pseudo-SHAP score for each group of features by summing the SHAP scores determined for the features in the respective group of features. At block 412, the risk assessment system determines a financial risk or a risk of fraud posed by the merchant based on the determined risk score and the pseudo-SHAP scores. In some instances, the machine learning model is trained using one or more historical sets of features associated with the merchant.

The one or more financial attributes includes one or more of an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant. Each group of features can be mapped to a corresponding category of financial attributes. In some instances, the mapping can be based on a correlation between the one or more attributes indicated in each feature of the set of features. The categories of financial attributes can include one or more of a duration of time between chargebacks to the merchant, a number of chargebacks to the merchant during a time period, or a dollar amounts of the chargebacks to the merchant during the time period.

FIG. 5A shows an illustrative flowchart depicting an example operation 500 for determining an impact value for a set of features, according to some implementations. The operation 500 can be performed by the risk assessment system 150 of FIG. 1 or the risk assessment system 200 of FIG. 2. In some instances, one or more portions of the operation 500 can be performed by the one or more processors 230 of FIG. 2. In some implementations, the operation 500 may be performed after determining the financial risk or the risk of fraud in block 412 of FIG. 4. For example, at block 502, the risk assessment system determines an impact value for each group of features, the impact value indicating a degree to which the respective group of features contributed to the risk score.

FIG. 5B shows an illustrative flowchart depicting an example operation 510 for applying weighting factors to one or more features of a merchant, according to some implementations. The operation 510 can be performed by the risk assessment system 150 of FIG. 1 or the risk assessment system 200 of FIG. 2. In some instances, one or more portions of the operation 510 can be performed by the one or more processors 230 of FIG. 2. In some implementations, the operation 510 may be performed after determining the financial risk or the risk of fraud in block 412 of FIG. 4. For example, at block 512, the risk assessment system determines a weighting factor for each feature of the set of features based at least in part on the one or more financial attributes indicated by the respective feature. At block 514, the risk assessment system applies the weighting factors to one or more of the features prior to determining the risk score.

FIG. 5C shows an illustrative flowchart depicting an example operation 520 for determining an accuracy of the risk score, according to some implementations. The operation 520 can be performed by the risk assessment system 150 of FIG. 1 or the risk assessment system 200 of FIG. 2. In some instances, one or more portions of the operation 520 can be performed by the one or more processors 230 of FIG. 2. In some implementations, the operation 520 may be performed after determining the financial risk or the risk of fraud in block 412 of FIG. 4. For example, at block 532, the risk assessment system provides the risk score, the determined pseudo-SHAP scores, and one or more financial transactions of the merchant to one or more human risk analysts associated with the electronic payment service. At block 524, the risk assessment system may receive, from the one or more human risk analysts, an indication of an accuracy of the determined risk score.

As used herein, a phrase referring to “at least one of” a list of items refers to any combination of those items, including single members. As an example, “at least one of: a, b, or c” is intended to cover: a, b, c, a-b, a-c, b-c, and a-b-c.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices such as, for example, a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that can be enabled to transfer a computer program from one place to another. A storage media may be any available media that may be accessed by a computer. By way of example, and not limitation, such computer-readable media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection can be properly termed a computer-readable medium. Disk and disc, as used herein, includes compact disc (CD), laser disc, optical disc, digital versatile disc (DVD), floppy disk, and blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

What is claimed is:

1. A method for identifying risky merchants associated with an electronic payment service, the method performed by a risk assessment system and comprising:
receiving a set of features indicative of one or more risks posed by a merchant enrolled in the electronic payment service, each feature of the set of features indicative of one or more financial attributes of the merchant;
determining a risk score for the merchant based on the set of features using a trained machine learning model;
determining a Shapely additive explanation (SHAP) score for each feature of the set of features;
dividing the set of features into multiple groups of features based on a mapping between each feature and the corresponding one or more financial attributes;
determining a pseudo-SHAP score for each group of features by summing the SHAP scores determined for the features in the respective group of features; and
determining a financial risk or a risk of fraud posed by the merchant based on the determined risk score and the pseudo-SHAP scores.

2. The method of claim 1, wherein the one or more financial attributes includes one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant.

3. The method of claim 1, wherein the machine learning model is trained using one or more historical sets of features associated with the merchant.

4. The method of claim 1, wherein each group of features corresponds to a different category of financial attributes.

5. The method of claim 1, wherein the mapping is based on similarities between the attributes indicated by each feature of the set of features.

6. The method of claim 1, further comprising:
determining an impact value for each group of features, the impact value indicating a degree to which the respective group of features contributed to the risk score.

7. The method of claim 1, further comprising:
determining a weighting factor for each feature of the set of features based at least in part on the one or more financial attributes indicated by the respective feature; and
applying the weighting factors to one or more of the features prior to determining the risk score.

8. The method of claim 1, further comprising:
providing the risk score, the pseudo-SHAP scores determined for the groups of features, and one or more financial transactions of the merchant to one or more human risk analysts associated with the electronic payment service.

9. The method of claim 8, further comprising:
receiving, from the one or more human risk analysts, an estimated accuracy of the risk score based at least in part on the pseudo-SHAP scores.

10. A risk assessment system for identifying risky merchants enrolled in an electronic payment service, the risk assessment system associated with the electronic payment service and comprising:
one or more processors; and
a memory coupled to the one or more processors and storing instructions that, when executed by the one or more processors, cause the risk assessment system to perform operations comprising:
receiving a set of features indicative of one or more risks posed by a merchant enrolled in the electronic payment service, each feature of the set of features indicative of one or more financial attributes of the merchant;
determining a risk score for the merchant based on the set of features using a trained machine learning model;
determining a Shapely additive explanation (SHAP) score for each feature of the set of features;
dividing the set of features into multiple groups of features based on a mapping between each feature and the corresponding one or more financial attributes;
determining a pseudo-SHAP score for each group of features by summing the SHAP scores determined for the features in the respective group of features; and
determining a financial risk or a risk of fraud posed by the merchant based on the determined risk score and the pseudo-SHAP scores.

11. The risk assessment system of claim 10, wherein the one or more financial attributes includes one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant.

12. The risk assessment system of claim 10, wherein the machine learning model is trained using one or more historical sets of features associated with the merchant.

13. The risk assessment system of claim 10, wherein each group of features corresponds to a different category of financial attributes.

14. The risk assessment system of claim 10, wherein the mapping is based on similarities between the attributes indicated by each feature of the set of features.

15. The risk assessment system of claim 10, wherein execution of the instructions causes the risk assessment system to perform operations further comprising:
determining an impact value for each group of features, the impact value indicating a degree to which the respective group of features contributed to the risk score.

16. The risk assessment system of claim 10, wherein execution of the instructions causes the risk assessment system to perform operations further comprising:
determining a weighting factor for each feature of the set of features based at least in part on the one or more financial attributes indicated by the respective feature; and
applying the weighting factors to one or more of the features prior to determining the risk score.

17. The risk assessment system of claim 10, wherein execution of the instructions causes the risk assessment system to perform operations further comprising:
providing the risk score, the pseudo-SHAP scores determined for the groups of features, and one or more financial transactions of the merchant to one or more human risk analysts associated with the electronic payment service.

18. The risk assessment system of claim 10, wherein execution of the instructions causes the risk assessment system to perform operations further comprising:
receiving, from the one or more human risk analysts, an estimated accuracy of the risk score based at least in part on the pseudo-SHAP scores.

19. An apparatus for identifying risky merchants enrolled in an electronic payment service, the apparatus associated with the electronic payment service and comprising:
means for receiving a set of features indicative of one or more risks posed by a merchant enrolled in the electronic payment service, each feature of the set of features indicative of one or more financial attributes of the merchant;
means for determining a risk score for the merchant based on the set of features using a trained machine learning model;
means for determining a Shapely additive explanation (SHAP) score for each feature of the set of features;
means for dividing the set of features into multiple groups of features based on a mapping between each feature and the corresponding one or more financial attributes;
means for determining a pseudo-SHAP score for each group of features by summing the SHAP scores determined for the features in the respective group of features; and
means for determining a financial risk or a risk of fraud posed by the merchant based on the determined risk score and the pseudo-SHAP scores.

20. The apparatus of claim 19, wherein the one or more financial attributes includes one or more of a duration of time between chargebacks to the merchant, a number of chargebacks to the merchant during a time period, a dollar amount of each chargeback to the merchant during the time period, an amount of outstanding debt of the merchant, a number of missed or insufficient payments by the merchant during a time period, a number of credit card authorization declines for the merchant during the time period, a credit score of the merchant, a length of credit history of the merchant, an amount of credit available to the merchant, a type of business handled by the merchant, or a type of customers associated with the merchant.
